(19) United States
(12) Patent Application Publication
(10) Pub. No.: US 2021/0309944 A1
(43) Pub. Date: Oct. 7, 2021

(54) METHOD AND APPARATUS FOR CLEANING FIREARM SUPPRESSORS

(71) Applicant: Otis Products, Inc. d/b/a Otis Technology, Lyons Falls, NY (US)

(72) Inventors: James R. Brooker, Constantia, NY (US); Chris Busch, Manlius, NY (US)

(73) Assignee: Otis Products, Inc. d/b/a Otis Technology, Lyons Falls, NY (US)

(21) Appl. No.: 17/223,550

(22) Filed: Apr. 6, 2021

Related U.S. Application Data
(60) Provisional application No. 63/006,228, filed on Apr. 7, 2020.

(51) Int. Cl. C11D 11/00; B08B 9/032; B08B 3/08; B08B 3/14; B08B 3/02; F41A 29/00; C11D 1/72; C11D 3/43; C11D 3/20; C11D 3/10; C11D 3/33; C11D 3/34

(52) U.S. Cl. CPC C11D 11/0029; F41A 21/30; B08B 3/08; B08B 3/14; B08B 3/02; B08B 9/0323; F41A 29/00; C11D 1/72; C11D 3/43; C11D 3/2086; C11D 3/10; C11D 3/33; C11D 3/349; B08B 2209/032; B08B 2203/007; B08B 2203/027; B08B 9/0325

(57) ABSTRACT

A method for cleaning a firearm suppressor having firing residue deposits on inner surfaces thereof, includes: providing a hydraulic system including a cleaning chamber, a turbulence-inducing nozzle, and a non-petroleum-based cleaning solution; installing a used firearm suppressor onto the turbulence-inducing nozzle; placing the used firearm suppressor into the cleaning chamber; tempering the non-petroleum-based cleaning solution to a temperature between about 120° F. and about 180° F.; and flowing the non-petroleum-based cleaning solution through the turbulence-inducing nozzle and the used firearm suppressor at a predetermined pressure and flow rate during a predetermined period of time. An apparatus for cleaning a firearm suppressor having internal baffles and expansion chambers is also described.

### CROSS-REFERENCE TO RELATED APPLICATIONS

This application claims priority to and the benefit of co-pending U.S. provisional patent application Ser. No. 63/006,228, METHOD AND APPARATUS FOR CLEANING FIREARM SUPPRESSORS, filed Apr. 7, 2020, which application is incorporated herein by reference in its entirety.

### FIELD of THE APPLICATION

The application relates to firearms, particularly to a method and apparatus for cleaning deposits from the interiors of firearm suppressors.

### BACKGROUND

Firearm suppressors reduce the sound and flash of firing of the firearm. Sound reduction benefits police and armed forces by reducing the signature of a firearm discharge to decrease the potential for detection by an adversary, while increasing situational awareness because personnel using or near the use of suppressed weapons do not have their hearing temporarily impaired by the loud sound of the discharge and reducing the potential for long-term hearing damage.

### SUMMARY

A method for cleaning a firearm suppressor having firing residue deposits on inner surfaces thereof, includes: providing a hydraulic system including a cleaning chamber, a turbulence-inducing nozzle, and a non-petroleum-based cleaning solution; installing a used firearm suppressor onto the turbulence-inducing nozzle; placing the used firearm suppressor into the cleaning chamber; tempering the non-petroleum-based cleaning solution to a temperature between about 100° F. and about 180° F.; and flowing the non-petroleum-based cleaning solution through the turbulence-inducing nozzle and the used firearm suppressor at a predetermined pressure and flow rate during a predetermined period of time.

The step of tempering can include tempering the non-petroleum-based cleaning solution to a temperature between about 140° F. and about 180° F. The step of flowing can include flowing the non-petroleum-based cleaning solution through the turbulence-inducing nozzle and the used firearm suppressor at a pressure and the flow rate of between about 50 PSI to 150 PSI. The step of flowing can include flowing the non-petroleum-based cleaning solution through the turbulence-inducing nozzle and the used firearm suppressor at a period of time of between one and twelve hours.

The non-petroleum-based cleaning solution can include a mixture of water; alcohols, C9-C11, ethoxylated; sodium citrate; sodium carbonate; tetrasodium glutamate diacetate; and citric acid. The non-petroleum-based cleaning solution can further include a mixture containing 5-Chloro-2-methyl-2H-isothiazol-3-one and 2-methyl-2H-isothiazol-3-one (3:1).

An apparatus for cleaning a firearm suppressor having internal baffles and expansion chambers includes a pump to circulate a cleaning solution through piping in the apparatus. A tempering element heats the cleaning solution to an elevated temperature. A cleaning chamber is dimensioned to accommodate at least one firearm suppressor. A removable cap has a passageway therethrough, and a discharge port. An adaptor is coupled to the passageway. The adaptor has a turbulence-inducing nozzle to create turbulent flow through at least the internal baffles and chambers of the at least one firearm suppressor and an attachment mechanism to mount the firearm suppressor thereto. A filtering element removes dislodged residue from the at least one firearm suppressor from the cleaning solution.

The apparatus can include electronic controls to regulate a pressure and a volume of the cleaning solution moving through the apparatus during a cleaning cycle. The apparatus can include electronic controls to regulate a temperature of the cleaning solution during a cleaning cycle. The apparatus can include electronic controls to regulate a length of a cleaning cycle. The apparatus can include electronic controls to regulate a backwashing or a cleaning of at least one filtering component. The apparatus can include electronic controls to regulate a draining and replacement of a spent cleaning fluid.

The apparatus can include a manifold fluidly connected to the cleaning chamber. The manifold can define a plurality of passageways opening into the cleaning chamber.

At least one adaptor is capable of attaching the at least one firearm suppressor to the apparatus. The apparatus can include a plurality of different types of adaptors to couple corresponding different types of firearm suppressors.

A plurality of firearm suppressors can be cleaned in a single cycle of the apparatus.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 is a cross-sectional view of an exemplary used firearm suppressor mounted to an adaptor and turbulence-inducing nozzle in accordance with the Application;

FIG. 2 is a schematic drawing of an exemplary hydraulic system for cleaning the used firearm suppressor shown in FIG. 1;

FIG. 3 is a photograph of an apparatus for cleaning a firearm suppressor showing front view including control display and removable cap;

FIG. 4 is a photograph of the apparatus of FIG. 3 showing the removable cap, adaptor and location of the turbulence-inducing nozzle;

FIG. 5 is a photograph of the apparatus of FIG. 3 showing the top view of the cleaning chamber;

FIG. 6 is a photograph of the apparatus of FIG. 3 showing the side view of the cleaning chamber and fluid discharge port;

FIG. 7 is a photograph of the apparatus of FIG. 3 showing the cleaning chamber, discharge port and external drain for removal of spent cleaning fluid; and

FIG. 8 is a photograph of the apparatus of FIG. 3 showing the electronic control compartment, circulation pump and cooling fan.

### DETAILED DESCRIPTION

Definitions

About—The word about as used herein is understood to mean +/−10% unless otherwise specified. In a range of values, it is understood that about refers to both the low value +/−10% and the high value +/−10%.

As described hereinabove, firearm suppressors reduce the sound and flash of firing of the firearm. Sound reduction benefits police and armed forces by reducing the signature of a firearm discharge to decrease the potential for detection by an adversary, while increasing situational awareness because personnel using or near the use of suppressed weapons do not have their hearing temporarily impaired by the loud sound of the discharge and reducing the potential for long-term hearing damage.

When firearms discharge, they produce superheated and pressurized gases. When the gases escape into the open, the change in environment causes the loud sound of a gun blast. Firearm suppressors work by making the transition more gradual for the resulting gasses. Inside the suppressors are baffles and expansion chambers to efficiently funnel, cool, and spread out the gasses to reduce their noise once they do reach the outside. Other benefits of a silencer include reduced recoil, better accuracy, and smaller muzzle flash.

Firearm suppressors attach to the muzzle of the barrel by various mechanisms. A common method is complementary threads, however, other suppressors use a locking quick attach mechanism. For example, a locking quick attach mechanism can include a mount on a flash hider or muzzle brake that is threaded onto the end of the barrel and the suppressor will lock onto the mount instead of threading directly onto the barrel.

During use, the baffles and expansion chambers of suppressors collect residue from the discharging gases that can impair functioning so that in subsequent firings the suppressor does not effectively reduce sound or flash signatures. In some circumstances, fouling can cause the suppressor or firearm to fail during use.

Firearm suppressors, particularly sealed suppressors, are difficult to clean. The fouling consists mainly of reaction products from the powder and primer in the ammunition cartridge, as well as fine metal particles from the projectile. The internal design of suppressors varies by model and manufacturer. In most cases, it is difficult to use common gun cleaning tools such as brushes or picks to effectively clean the inside of a fouled suppressor due to the complexity of the internal design, including inaccessible baffles and expansion chambers.

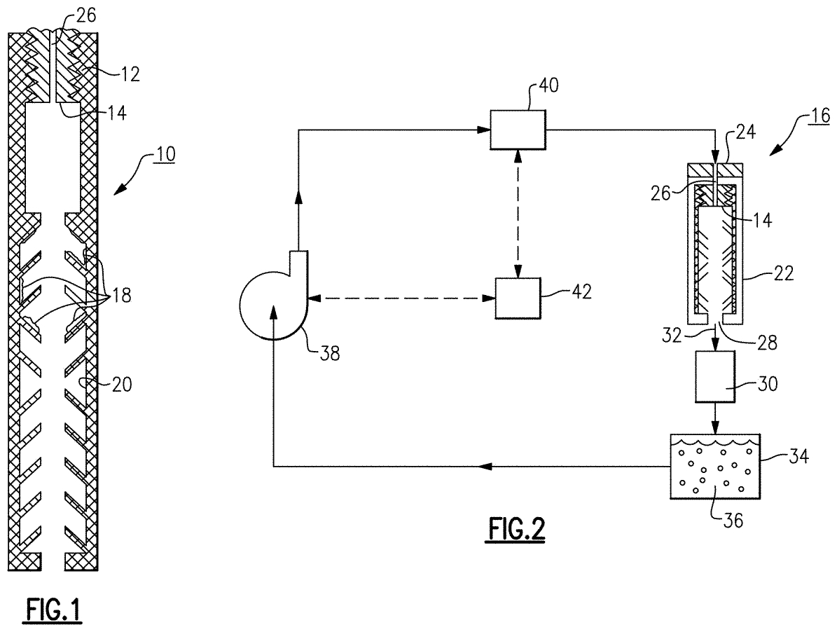

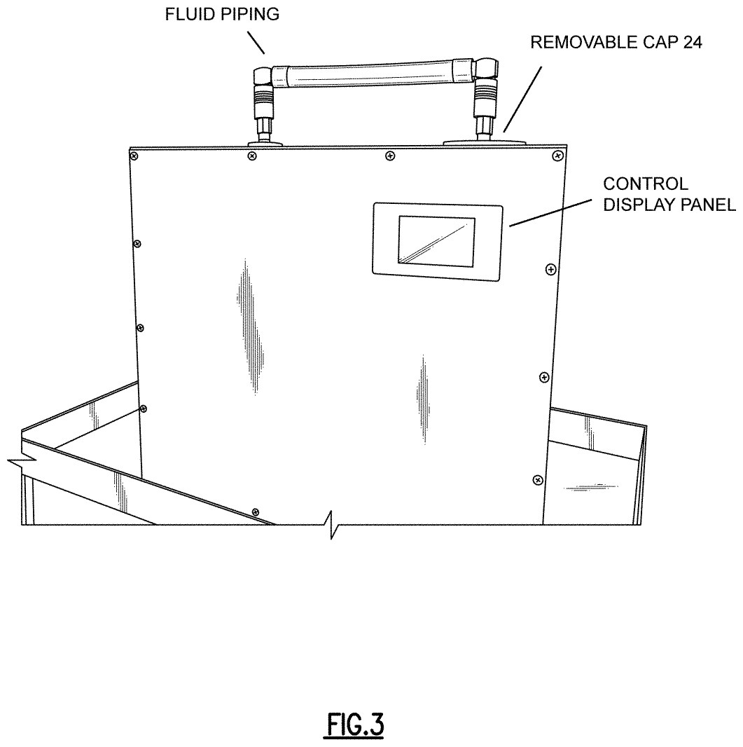

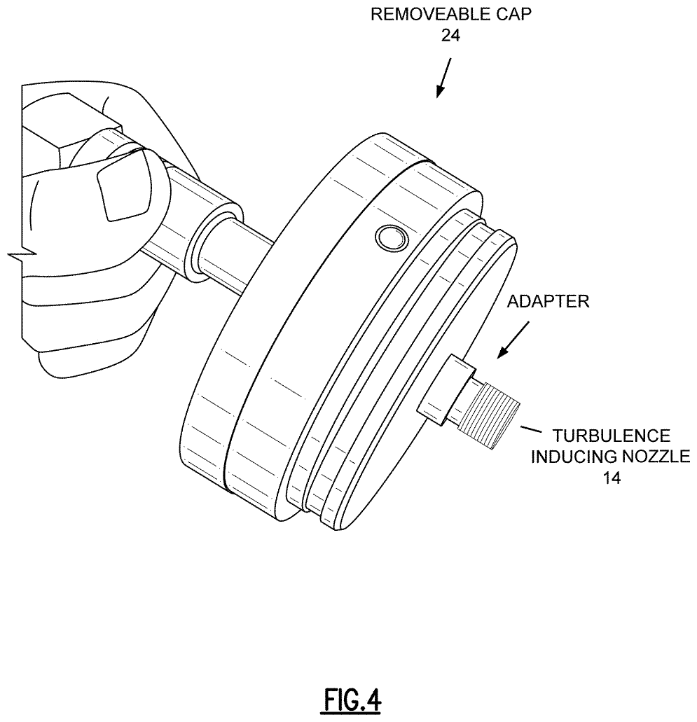

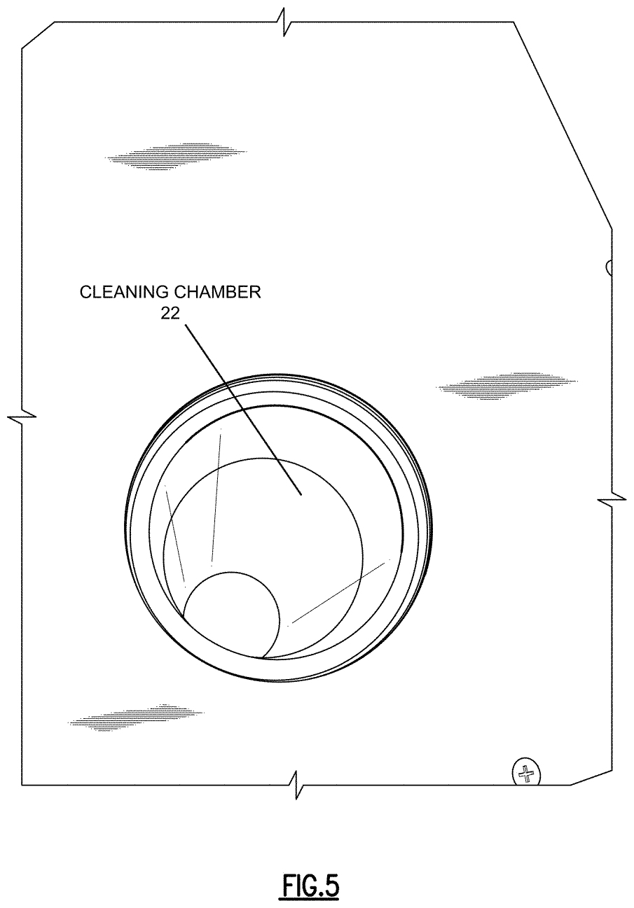

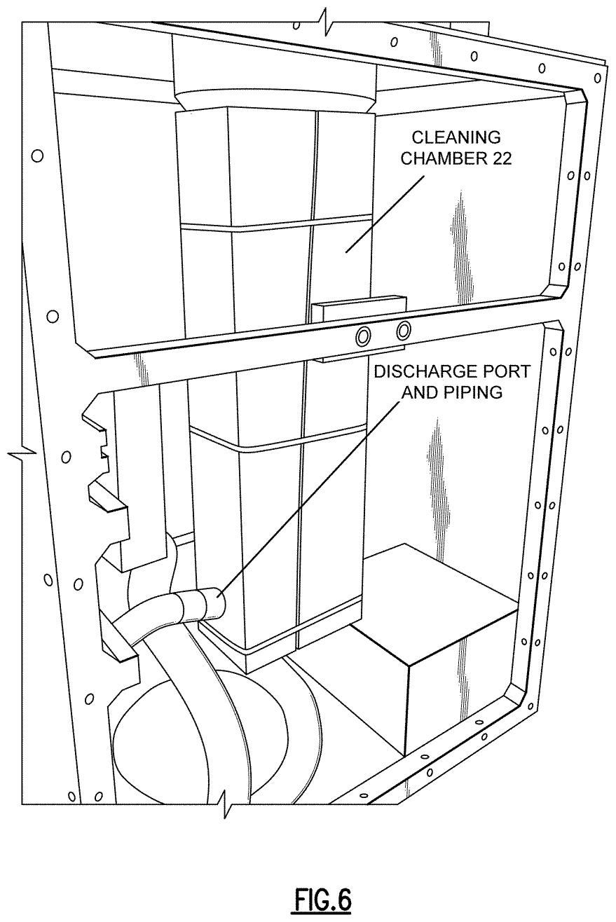

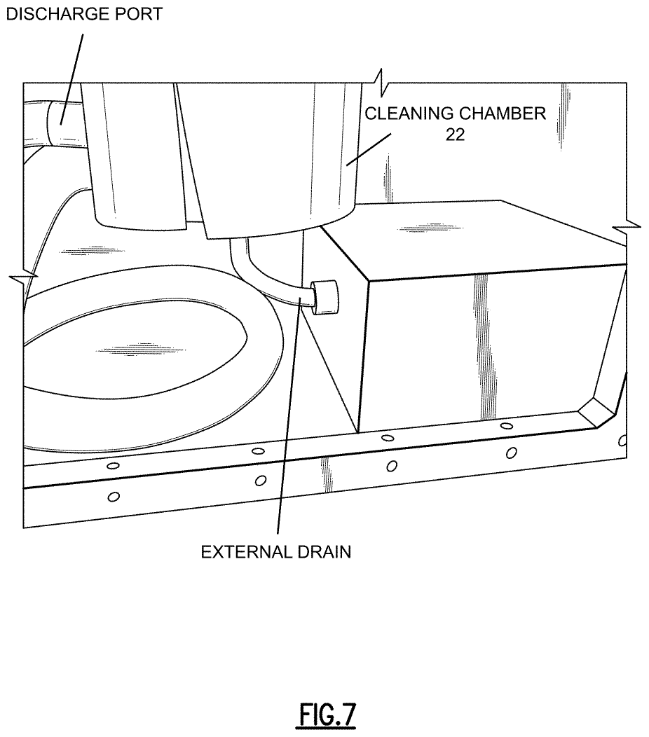

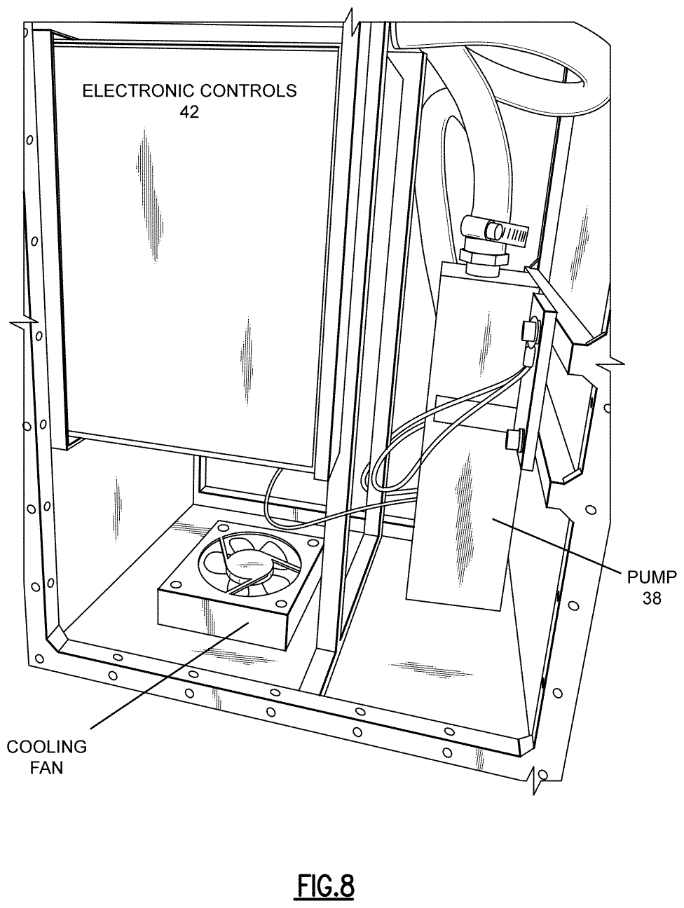

Referring to FIGS. 1 and 2, a cross-sectional view of an exemplary used firearm suppressor 10 is shown, attached by threaded attachment 12 to a turbulence-inducing nozzle 14 of a currently preferred system 16 for cleaning exemplary firing residue deposits 18 from the interior surfaces 20 of firearm suppressor 10. While a threaded attachment is displayed, the Application contemplates and includes adaptors that are compatible with a variety of locking quick connect mechanisms used on firearm suppressors.

System 16 comprises a cleaning chamber 22 of sufficient length and volume to accommodate one or more firearm suppressors and other firearm components, and the chamber can include a mesh basket for holding components and trapping relatively larger pieces of dislodged residue. The cleaning chamber has a removable cap 24 having a passageway 26 therethrough and a drain opening 28. The cap or other portion of the chamber is removable in order to permit the placement of suppressors or other firearm components and accessories into the chamber for cleaning. Connected to a passageway is an adaptor for connecting the threads or attachment mechanism of the suppressor thereto. The adaptor includes a turbulence-inducing nozzle 14 to pass a turbulent flow of cleaning solution through and around the suppressor. Turbulence of the flow enhances cleaning by forcing cleaning fluid into and through the baffles and expansion chambers of the firearm suppressor.

The cleaning chamber further includes a discharge port that can be located a short distance above the bottom of the chamber to allow for the accumulation of dislodged residue within the lower portion of the chamber. The discharge port is fluidly connected by return line to the intake of the heater and/or pump.

A filter, screen, or mesh 30 is disposed within the outflow path 32 of spent fluid being discharged from cleaning chamber 22. The cleaning system can include filtering for removing fine particulate and dissolved residue from the cleaning fluid after discharge from the cleaning chamber. A filter, screen, or mesh 30 can be disposed within the outflow path 32 of cleaning fluid being discharged from the drain opening of the cleaning chamber 22. The filtering can include a sensor to inform the user that the cleaning fluid requires replacement. The sensor can be a pressure sensing switch or indicator or can include a source of light directed into or through a portion of the cleaning fluid and an optical sensor to measure light that is either reflected from or passed through the cleaning fluid. The sensor can be connected to the electronic controls of the system to alert the operator of the need to drain and replace spent cleaning fluid. Electronic controls can also be programmed to activate a drain valve in the system to automatically drain the spent cleaning fluid and refill the system from an external tank or supply of fresh cleaning solution for continued operation.

A reservoir 34 containing a non-petroleum-based cleaning solution 36 is disposed to receive cleaning solution from the filter, screen, or mesh 30, and further is connected to a controllable pump 38 and solution tempering system 40 that in turn is connected to the entrance to passage 26 in removable cap 24, thus defining a closed recirculation system 16 for pumping cleaning solution through a turbulence-inducing nozzle and a firearm suppressor for a predetermined time period, for example between about one and twelve hours depending on the amount of the deposits or residues accumulated on the surfaces of the suppressor. The solution temperature can be between about 100° F. to 180° F., preferably about 140° F. to 180° F., the flow rate is about three to ten gallons per minute, and the pump pressure is between about 50 to 150 PSI. System parameters are controlled by an electronic controller 42, and an optical or pressure sensing system (not shown) can be included to detect solution concentration of particulate and carbon debris.

A currently preferred non-petroleum-based cleaning solution 36 is available under the trade name SHOOTER'S CHOICE Ultrasonic Cleaner, having the following ingredients: water; alcohols, C9-C11, ethoxylated; sodium citrate; sodium carbonate; tetrasodium glutamate diacetate; citric acid; mixture containing 5-Chloro-2-methyl-2H-isothiazol-3-one and 2-methyl-2H-isothiazol-3-one (3:1). The solution can also include colorants and fragrances.

Other types and formulations of non-petroleum-based cleaning solutions also are contemplated by the Application, including industrial and household cleaning solutions such as those manufactured and sold under the trade name SIMPLE GREEN.

In operation, cap 24 is removed from chamber 22. A firearm suppressor in need of cleaning is connected onto the adaptor such that turbulence-inducing nozzle 14 is directed into and through the inner passages, baffles and chambers of the suppressor, and cap 24 is replaced to seal the cleaning chamber 22. Other configurations of doors and sealed openings to the cleaning chamber are contemplated by the Application that permit the insertion of suppressors into the chamber and connection to the turbulence-inducing nozzle within the chamber. Reservoir 34 is filled with cleaning solution 36. Controller 42 is energized, followed by pump 38 and tempering system 40. Cleaning solution 36 is then circulated through system 16 and firearm suppressor 10 at a predetermined pressure and flow rate. The cleaning solution 36 is heated to a predetermined temperature, and is circulated through the system for a predetermined period of time, during which firing residue deposits 18 are removed from surfaces 20 of firearm suppressor 10, including from the baffles and chambers that are inaccessible to manual cleaning by tools such as brushes, pics, tips and slots. At the conclusion of a cleaning cycle, pump 38 is stopped and solution in chamber 22 and firearm suppressor 10 can be drained from the cleaning chamber into reservoir 36. Firearm suppressor 10 is removed from system 16, then rinsed with water and dried in known fashion. The system can include a heat exchanger, including, for example, finned tubing or coils, and/or cooling fan directed over the heat exchanger to allow for more rapid cooling of the cleaning fluid after the completion of the cleaning cycle. Air flow from the cooling fan can also be directed over the electronic controls when not functioning to cool the heated cleaning solution after completion of a cleaning cycle.

The system can include a manifold assembly fluidly connected to the passageways in the cap, top or wall of the cleaning chamber. The manifold can split the flow from the circulation pump or tempering element to a plurality of passageways through the interior wall of the cleaning chamber. The manifold assembly can be a separate component or integral to the removable cap of the cleaning chamber. Multiple passageways from the manifold can include multiple adaptors and turbulence inducing nozzles to permit the simultaneous cleaning of a plurality of firearm suppressors or other components during a single cleaning cycle. Multiple suppressors can then be cleaned and processed in batches for efficient cleaning thereof.

The system includes electronic controls interconnected to a processor, sensors and functional elements of the system to regulate (1) the pressure and volume of the cleaning fluid moving through the system during a cleaning cycle; (2) the temperature of the cleaning solution during the cleaning cycle; (3) the length of the cleaning cycle; (4) backwashing or cleaning of the filtering components; and/or (5) the draining and replacement of the spent cleaning fluid.

It will be appreciated that variants of the above-disclosed and other features and functions, or alternatives thereof, can be combined into many other different systems or applications. Various presently unforeseen or unanticipated alternatives, modifications, variations, or improvements therein can be subsequently made by those skilled in the art which are also intended to be encompassed by the following claims.

What is claimed is:

1. A method for cleaning a firearm suppressor having firing residue deposits on inner surfaces thereof, comprising:
providing a hydraulic system including a cleaning chamber, a turbulence-inducing nozzle, and a non-petroleum-based cleaning solution;
installing a used firearm suppressor onto said turbulence-inducing nozzle;
placing the used firearm suppressor into said cleaning chamber;
tempering said non-petroleum-based cleaning solution to a temperature between about 100° F. and about 180° F.; and
flowing said non-petroleum-based cleaning solution through said turbulence-inducing nozzle and said used firearm suppressor at a predetermined pressure and flow rate during a predetermined period of time.

2. The method of claim 1, wherein said step of tempering comprises tempering said non-petroleum-based cleaning solution to said temperature between about 140° F. and about 180° F.

3. The method of claim 1, wherein said step of flowing comprises flowing said non-petroleum-based cleaning solution through said turbulence-inducing nozzle and said used firearm suppressor at a pressure and said flow rate of between about 50 PSI to about 150 PSI.

4. The method of claim 1, wherein said step of flowing comprises flowing said non-petroleum-based cleaning solution through said turbulence-inducing nozzle and said used firearm suppressor at a period of time of between one and twelve hours.

5. The method of claim 1 wherein said non-petroleum-based cleaning solution comprises a mixture of water; alcohols, C9-C11, ethoxylated; sodium citrate; sodium carbonate; tetrasodium glutamate diacetate; and citric acid.

6. The method of claim 1 wherein said non-petroleum-based cleaning solution further comprises a mixture containing 5-Chloro-2-methyl-2H-isothiazol-3-one and 2-methyl-2H-isothiazol-3-one (3:1).

7. An apparatus for cleaning a firearm suppressor having internal baffles and expansion chambers, the apparatus comprising:
a pump to circulate a cleaning solution through piping in the apparatus;
a tempering element to heat the cleaning solution to an elevated temperature;
a cleaning chamber dimensioned to accommodate at least one firearm suppressor, a removable cap having a passageway therethrough, and a discharge port;
an adaptor coupled to the passageway, said adaptor having a turbulence-inducing nozzle to create turbulent flow through at least the internal baffles and chambers of the at least one firearm suppressor and an attachment mechanism to mount the firearm suppressor thereto; and
a filtering element to remove dislodged residue from the at least one firearm suppressor from the cleaning solution.

8. The apparatus of claim 7, wherein the apparatus includes electronic controls to regulate a pressure and a volume of the cleaning solution moving through the apparatus during a cleaning cycle.

9. The apparatus of claim 7, wherein the apparatus includes electronic controls to regulate a temperature of the cleaning solution during a cleaning cycle.

10. The apparatus of claim 7, wherein the apparatus includes electronic controls to regulate a length of a cleaning cycle.

11. The apparatus of claim 7, wherein the apparatus includes electronic controls to regulate a backwashing or a cleaning of at least one filtering component.

12. The apparatus of claim 7, wherein the apparatus includes electronic controls to regulate a draining and replacement of a spent cleaning fluid.

13. The apparatus of claim 7, comprising a manifold fluidly connected to the cleaning chamber.

14. The apparatus of claim 13, wherein said manifold defines a plurality of passageways opening into the cleaning chamber.

15. The apparatus of claim 13, wherein at least one adaptor is capable of attaching the at least one firearm suppressor to said apparatus.

16. The apparatus of claim 13, comprising a plurality of different types of adaptors to couple corresponding different types of firearm suppressors.

17. The apparatus of claim 13, wherein a plurality of firearm suppressors can be cleaned in a single cycle of said apparatus.
